(19) United States
(12) Patent Application Publication
(10) Pub. No.: US 2017/0357412 A1
(43) Pub. Date: Dec. 14, 2017

(54) DATA CREATING DEVICE, DATA CREATING METHOD, AND DATA CREATING PROGRAM

(71) Applicant: Mitsubishi Electric Corporation, Tokyo (JP)

(72) Inventor: Yuki SHIODE, Tokyo (JP)

(73) Assignee: Mitsubishi Electric Corporation, Tokyo (JP)

(21) Appl. No.: 15/540,281

(22) PCT Filed: Feb. 23, 2015
(86) PCT No.: PCT/JP2015/055078

§ 371 Date: Jun. 28, 2017

(51) Int. Cl. G06F 3/0484; G06F 9/44; G06F 17/30

(52) U.S. Cl. CPC G06F 3/04842; G06F 17/30607; G06F 8/70; G06F 9/4443

(57) ABSTRACT

A data creating device includes: a storage unit to store library data in which character strings are correlated with objects for displaying data acquired from a control device or sending data to the control device; a recognition processing unit to recognize a character string drawn in one or more pieces of image data; a screen data creation processor to search the library data using the character string recognized by the recognition processor to acquire an object correlated with the character string recognized by the recognition processing unit, and create one or more pieces of screen data in which the acquired object is arranged; and a device name input processing unit to accept input of a device name to the object arranged in the one or more pieces of screen data, the device name uniquely specifying a memory area in the control device.

### FIELD

The present invention relates to a data creating device, a data creating method, and a data creating program for creating data for displaying a screen on a programmable display (JIS B 3551: 2012).

### BACKGROUND

A programmable controller (JIS B 3502: 2011, PLC) is used to control operation of an industrial machine. A programmable display is used to enable an operator to monitor data in the PLC.

The programmable display can store a plurality of pieces of screen data and switch between a plurality of screens for display.

In each piece of screen data, a device name for uniquely specifying a memory area in the PLC to be referred to and monitored through each screen and a device name for uniquely specifying a memory area in the PLC to which data input to each screen are transferred are described. Consequently, data to be monitored are displayed in each screen, and data input in each screen are transferred to the PLC. The device name is a name systematically assigned by a vendor of the PLC to each memory area.

The screen data for displaying the screen on the programmable display are created when a screen data creating program for the programmable display is executed on a computer.

### CITATION LIST

### Patent Literature

Patent Literature 1: Japanese Patent Application Laid-Open No. H8-166865

Patent Literature 2: Japanese Patent Application Laid-Open No. 2001-266171

Patent Literature 3: Japanese Patent Application Laid-Open No. 2008-217573

### SUMMARY

### Technical Problem

The screen data for displaying the screen on the programmable display are sometimes created on the basis of image data created in a way different from the use of the screen data creating program for the programmable display. In this case, since the operator has to create the screen data from the beginning while watching an image that is based on the image data, the operator's workload is increased, and a human error might be caused by the operator.

Patent Literature 1 describes a method of generating a screen. Specifically, a graphical user interface screen is automatically generated on the basis of layout information created on a sheet of paper (refer to Abstract). An object in the screen data for use in the programmable display needs to include information for requesting data to be monitored from the PLC or information for transferring input data to the PLC. However, a component displayed in the graphical user interface screen generated using the technique described in Patent Literature 1 does not include information for requesting data to be monitored from the PLC or information for transferring input data to the PLC. Therefore, the graphical user interface screen generated using the technique described in Patent Literature 1 cannot be used in the programmable display.

Patent Literature 2 describes a plotting device that creates a control screen for display on the programmable display. Patent Literature 2 also describes an idea of displaying an attribute value of an object in an editable state (refer to Paragraphs 0052 to 0056). The attribute value described in Patent Literature 2 is an attribute value related to an image aspect of the object, examples of which include a shape, a position, a size, a color, and a fill setting. However, Patent Literature 2 does not describe an object including information for requesting data to be monitored from the PLC or information for transferring input data to the PLC.

Patent Literature 3 describes an information processing device that generates information for displaying a display screen on a display device. Patent Literature 3 describes a button, a text, an icon, and a background or the like as screen elements in the display screen (refer to Paragraph 0032). However, Patent Literature 3 does not describe an object including information for requesting data to be monitored from the PLC or information for transferring input data to the PLC.

The present invention has been made in consideration of the above-mentioned circumstances, and an object thereof is to obtain a data creating device capable of reducing an operator's workload and suppressing a human error by the operator.

### Solution to Problem

A data creating device according to the present invention includes a storage unit to store library data in which figures and character strings or figures and colors are correlated with objects for displaying data acquired from a control device or sending data to the control device.

A data creating device according to the present invention includes a recognition processing unit to recognize a figure and a character string, a character string, or a figure and a color drawn in one or more pieces of image data, and a screen data creation processing unit to search the library data using the figure and the character string, the character string, or the figure and the color recognized by the recognition processing unit to acquire an object correlated with the figure and the character string, the character string, or the figure and the color recognized by the recognition processing unit, and create one or more pieces of screen data in which the acquired object is arranged.

A data creating device according to the present invention includes a device name input processing unit to accept input of a device name to the object arranged in the one or more pieces of screen data, the device name uniquely specifying a memory area in the control device.

### Advantageous Effects of Invention

The present invention can achieve an effect of reducing an operator's workload and suppressing a human error by the operator.

### BRIEF DESCRIPTION OF DRAWINGS

FIG. 1 is a diagram illustrating a configuration of a control system including a data creating device according to a first embodiment.

FIG. 2 is a diagram illustrating a hardware configuration of a programmable display according to the first embodiment.

FIG. 3 is a diagram illustrating a hardware configuration of the data creating device according to the first embodiment.

FIG. 4 is a functional block diagram of the data creating device according to the first embodiment.

FIG. 5 is a flowchart illustrating a data creating process of the data creating device according to the first embodiment.

FIG. 6 is a flowchart illustrating a subroutine for a screen transition information input process according to the first embodiment.

FIG. 7 is a diagram illustrating exemplary image data according to the first embodiment.

FIG. 8 is a diagram illustrating exemplary screen data according to the first embodiment.

FIG. 9 is a diagram illustrating exemplary image data according to the first embodiment.

FIG. 10 is a diagram illustrating a device name input dialogue box according to the first embodiment.

FIG. 11 is a diagram illustrating a plurality of pieces of image data according to the first embodiment.

FIG. 12 is a diagram illustrating a plurality of pieces of screen data according to the first embodiment.

FIG. 13 is a diagram illustrating an exemplary screen transition information input dialogue box according to the first embodiment.

FIG. 14 is a diagram illustrating exemplary library data according to the first embodiment.

### DESCRIPTION OF EMBODIMENTS

Hereinafter, a data creating device, a data creating method, and a data creating program according to an embodiment of the present invention will be described in detail based on the drawings. The present invention is not limited to the embodiment.

### First Embodiment

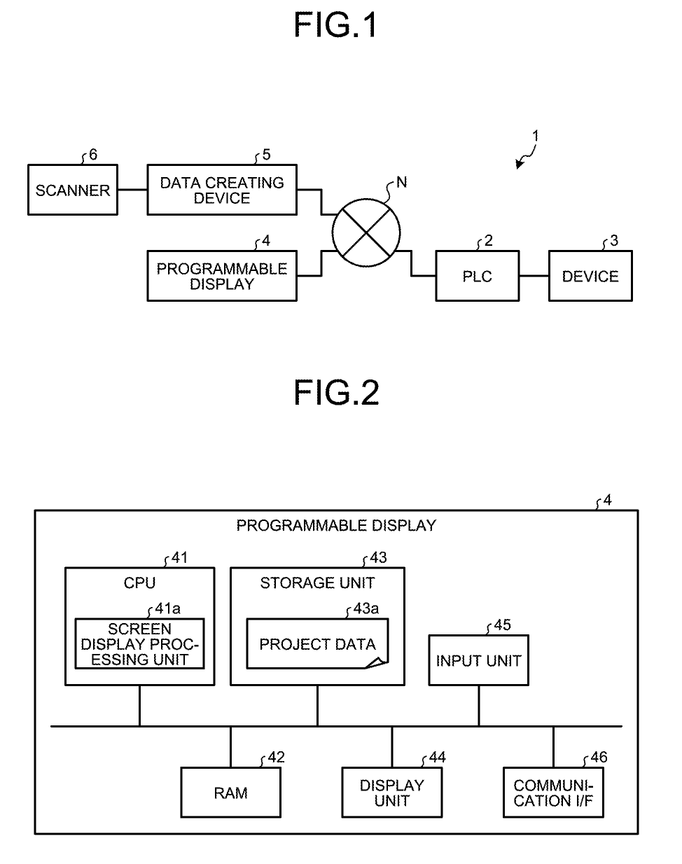

FIG. 1 is a diagram illustrating a configuration of a control system including a data creating device according to a first embodiment. The control system 1 includes a PLC 2, a device 3, a programmable display 4, the data creating device 5, and a scanner 6. The PLC 2, the programmable display 4, and the data creating device 5 are connected via a network N so as to be capable of communicating with one another. The PLC 2 is connected to the device 3 to control the operation of the device 3, e.g., an industrial machine.

The programmable display 4 and the data creating device 5 may be directly connected to each other, instead of being connected via the network N. A unit for realizing the direct connection is exemplified by a universal serial bus (USB).

FIG. 2 is a diagram illustrating a hardware configuration of the programmable display according to the first embodiment. The programmable display 4 includes a central processing unit (CPU) 41, a random access memory (RAM) 42, a storage unit 43, a display unit 44, an input unit 45, and a communication interface 46.

The CPU 41 executes a screen display processing program stored in the storage unit 43 while using the RAM 42 as a work area. Consequently, a screen display processing unit 41a is realized. The storage unit 43 stores project data 43a created and transferred by the data creating device 5. The project data 43a include one or more pieces of screen data.

The display unit 44 displays characters and images. The input unit 45 accepts input from an operator. The communication interface 46 communicates with another device.

The programmable display 4 can display a screen based on the screen data in the project data 43a. In the screen data, a device name for uniquely specifying a memory area in the PLC 2 to be referred to and monitored through the screen is described. Consequently, data to be monitored are displayed in the screen.

The programmable display 4 needs to request data from the PLC 2 or send data to the PLC 2 using the device name for uniquely specifying each memory area in the PLC 2 when the programmable display 4 requests data to be monitored from the PLC 2 or sends data to the PLC 2. The device name is a name systematically assigned by a vendor of the PLC 2 to each memory area.

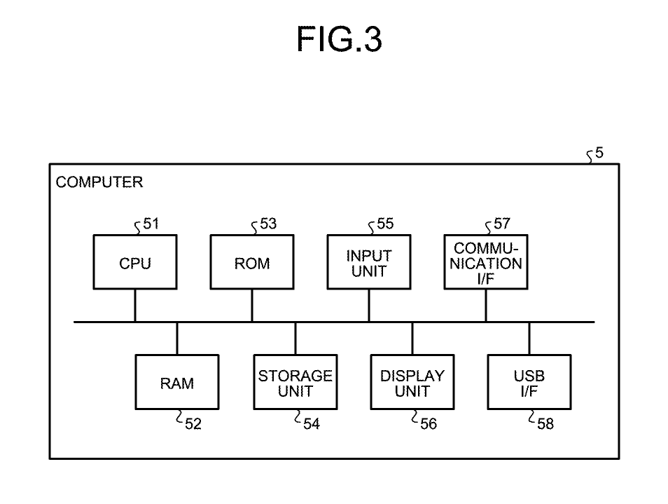

FIG. 3 is a diagram illustrating a hardware configuration of the data creating device according to the first embodiment. The data creating device 5 according to the first embodiment is a computer. The data creating device 5 includes a CPU 51, a RAM 52, a read only memory (ROM) 53, a storage unit 54, an input unit 55, a display unit 56, a communication interface 57, and a USB interface 58.

The CPU 51 executes programs stored in the ROM 53 and the storage unit 54 while using the RAM 52 as a work area. The program stored in the ROM 53 is exemplified by a basic input/output system (BIOS) or a unified extensible firmware interface (UEFI). The program stored in the storage unit 54 is exemplified by an operating system program and a data editing program. The storage unit 54 is exemplified by a solid state drive (SSD) or a hard disk drive (HDD).

The input unit 55 accepts operation input from the operator. The input unit 55 is exemplified by a keyboard or a mouse. The display unit 56 displays characters and images. The display unit 56 is exemplified by a liquid crystal display device. The communication interface 57 communicates with another device via the network N. The USB interface 58 is connected to the scanner 6 to receive image data scanned by the scanner 6.

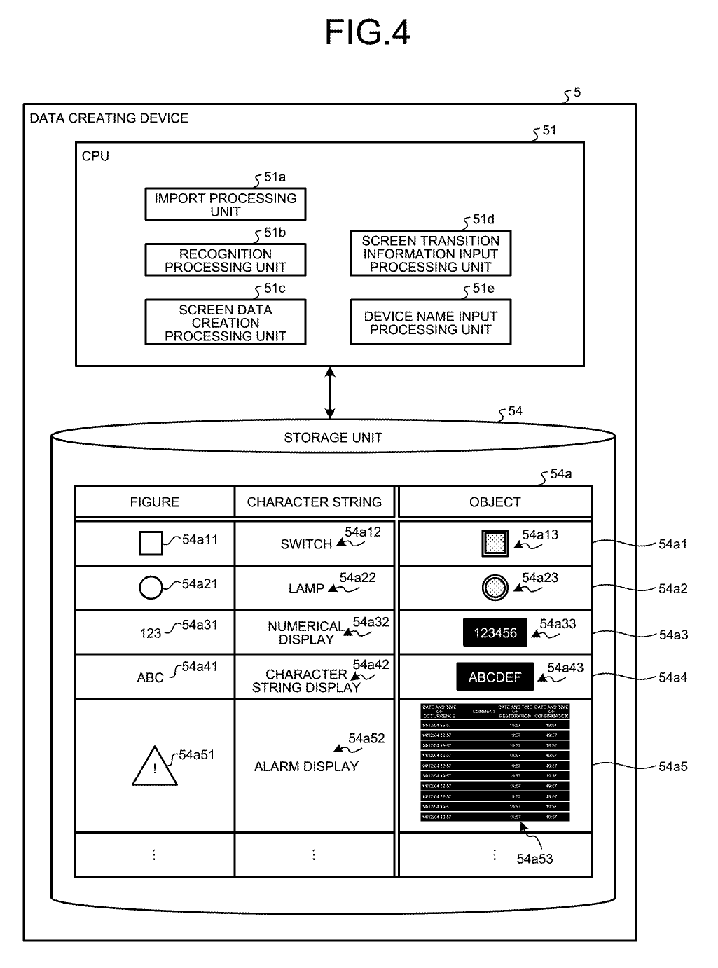

FIG. 4 is a functional block diagram of the data creating device according to the first embodiment. The storage unit 54 stores library data 54a in which figures and character strings are correlated with objects. Each of the objects is an image for display in a screen that is displayed on the display unit 44 of the programmable display 4.

In a first row 54a1 of the library data 54a, a quadrilateral 54a11 and a character string “switch” 54a12 are correlated with an object 54a13. The object 54a13 is a switch image for display in a screen that is displayed on the display unit 44 of the programmable display 4.

In a second row 54a2 of the library data 54a, a circle 54a21 and a character string “lamp” 54a22 are correlated with an object 54a23. The object 54a23 is a lamp image for display in a screen that is displayed on the display unit 44 of the programmable display 4.

In a third row 54a3 of the library data 54a, a FIG. 54a31 of bold “123” and a character string “numerical display” 54a32 are correlated with an object 54a33. The object 54a33 is a numerical display image for display in a screen that is displayed on the display unit 44 of the programmable display 4.

In a fourth row 54a4 of the library data 54a, a FIG. 54a41 of bold “ABC” and a character string “character string display” 54a42 are correlated with an object 54a43. The object 54a43 is a character string display image for display in a screen that is displayed on the display unit 44 of the programmable display 4.

In a fifth row 54a5 of the library data 54a, a FIG. 54a51 of an exclamation mark drawn in a triangle and a character string “alarm display” 54a52 are correlated with an object 54a53. The object 54a53 is an alarm display image for display in a screen that is displayed on the display unit 44 of the programmable display 4.

The CPU 51 executes a data creating program stored in the storage unit 54. Consequently, an import processing unit 51a, a recognition processing unit 51b, a screen data creation processing unit 51c, a screen transition information input processing unit 51d, and a device name input processing unit 51e are realized. The import processing unit 51a imports one or more pieces of image data. The recognition processing unit 51b recognizes a figure, a character string, or a figure and a color drawn in the one or more pieces of image data. The screen data creation processing unit 51c searches the library data 54a using the figure, the character string, or the figure and the color recognized by the recognition processing unit 51b to acquire an object correlated with the figure, the character string, or the figure and the color recognized by the recognition processing unit 51b. The screen data creation processing unit 51c then creates one or more pieces of screen data in which the acquired object is arranged. The screen transition information input processing unit 51d arranges a screen transition object in each of the pieces of screen data in response to the screen data creation processing unit 51c creating the pieces of screen data. The screen transition information input processing unit 51d then accepts input of screen transition information to the screen transition object in each of the pieces of screen data. The screen transition object indicates a piece of screen data that is reached as a transition destination when the screen transition object is selected. The device name input processing unit 51e accepts input of a device name to the object arranged in the one or more pieces of screen data. The device name uniquely specifies a memory area in the PLC 2.

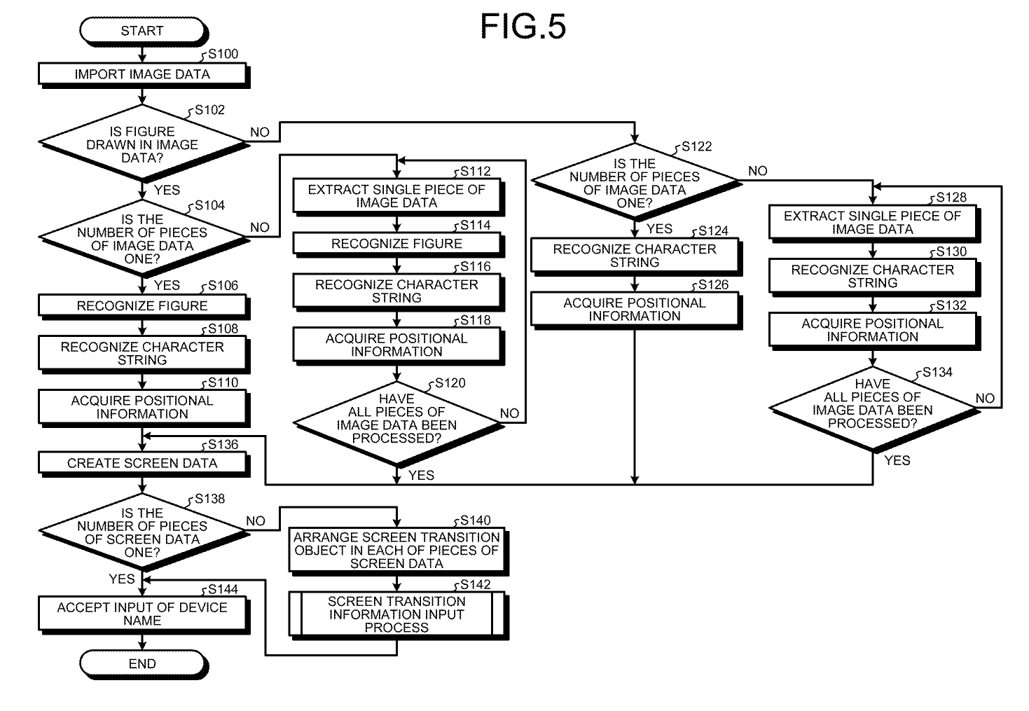

Next, the operation of the data creating device 5 will be described. FIG. 5 is a flowchart illustrating a data creating process of the data creating device according to the first embodiment.

First, the import processing unit 51a imports one or more pieces of image data in step S100. The import processing unit 51a can import image data by scanning a sheet of paper using the scanner 6. The import processing unit 51a causes the storage unit 54 to store the imported image data. Alternatively, the import processing unit 51a can import image data by reading the image data stored in an external storage device. The external storage device is exemplified by an SD card (registered trademark). Still alternatively, the CPU 51 can execute a paint program or a presentation program to create image data, and the import processing unit 51a can import the created image data stored in the storage unit 54. The presentation program is exemplified by Microsoft PowerPoint (registered trademark). The image data are exemplified by bitmap data, joint photographic experts group (JPEG) data, or PowerPoint (registered trademark) data.

Next, the recognition processing unit 51b determines in step S102 whether a figure is drawn in the imported image data. When the recognition processing unit 51b determines in step S102 that a figure is drawn in the imported image data (Yes), the recognition processing unit 51b advances the process to step S104.

The recognition processing unit 51b determines in step S104 whether the number of pieces of imported image data is one. When the recognition processing unit 51b determines in step S104 that the number of pieces of imported image data is one (Yes), the recognition processing unit 51b advances the process to step S106.

In step S106, the recognition processing unit 51b recognizes the figure drawn in the imported image data. A known figure recognition technique is utilized for the recognition of the figure.

Next, the recognition processing unit 51b recognizes a character string drawn in the imported image data in step S108. A known character string recognition technique is utilized for the recognition of the character string.

Next, the recognition processing unit 51b acquires positional information of the figure and the character string drawn in the imported image data in step S110. Next, the recognition processing unit 51b advances the process to step S136.

Returning to step S104, when the recognition processing unit 51b determines that the number of pieces of imported image data is not one (No), the recognition processing unit 51b advances the process to step S112.

In step S112, the recognition processing unit 51b extracts a single piece of image data.

Next, the recognition processing unit 51b recognizes the figure drawn in the imported image data in step S114.

Next, the recognition processing unit 51b recognizes a character string drawn in the imported image data in step S116.

Next, the recognition processing unit 51b acquires positional information of the figure and the character string drawn in the imported image data in step S118.

Next, the recognition processing unit 51b determines in step S120 whether all the pieces of image data have been processed. When the recognition processing unit 51b determines in step S120 that all the pieces of image data have been processed (Yes), the recognition processing unit 51b advances the process to step S136. On the other hand, when the recognition processing unit 51b determines in step S120 that not all the pieces of image data have been processed (No), the recognition processing unit 51b advances the process to step S112.

Returning to step S102, when the recognition processing unit 51b determines that a figure is not drawn in the imported image data (No), the recognition processing unit 51b advances the process to step S122.

The recognition processing unit 51b determines in step S122 whether the number of pieces of imported image data is one. When the recognition processing unit 51b determines in step S122 that the number of pieces of imported image data is one (Yes), the recognition processing unit 51b advances the process to step S124.

In step S124, the recognition processing unit 51b recognizes a character string drawn in the imported image data.

Next, the recognition processing unit 51b acquires positional information of the character string drawn in the imported image data in step S126. Next, the recognition processing unit 51b advances the process to step S136.

Returning to step S122, when the recognition processing unit 51b determines that the number of pieces of imported image data is not one (No), the recognition processing unit 51b advances the process to step S128.

In step S128, the recognition processing unit 51b extracts a single piece of image data.

Next, the recognition processing unit 51b recognizes a character string drawn in the imported image data in step S130.

Next, the recognition processing unit 51b acquires positional information of the character string drawn in the imported image data in step S132.

Next, the recognition processing unit 51b determines in step S134 whether all the pieces of image data have been processed. When the recognition processing unit 51b determines in step S134 that all the pieces of image data have been processed (Yes), the recognition processing unit 51b advances the process to step S136. On the other hand, when the recognition processing unit 51b determines in step S134 that not all the pieces of image data have been processed (No), the recognition processing unit 51b advances the process to step S128.

Next, in step S136, the screen data creation processing unit 51c searches the library data 54a using the figure or the character string recognized by the recognition processing unit 51b, acquires an object correlated with the figure or the character string recognized by the recognition processing unit 51b, and creates screen data. The screen data creation processing unit 51c creates a single piece of screen data when the number of pieces of image data is one, and creates a plurality of pieces of screen data when the number of pieces of image data is more than one.

The screen data is exemplified by text data described using a description language. The description language is exemplified by a hyper text markup language (HTML).

Next, the screen transition information input processing unit 51d determines in step S138 whether the number of pieces of screen data is one. The screen transition information input processing unit 51d advances the process to step S140 when the screen transition information input processing unit 51d determines in step S138 that the number of pieces of screen data is not one (No), and advances the process to step S144 when the screen transition information input processing unit 51d determines in step S138 that the number of pieces of screen data is one (Yes).

Next, the screen transition information input processing unit 51d arranges a screen transition object in each of the pieces of screen data in step S140. The screen transition object is an object for changing the display screen to another screen in response to being selected by a manipulator for the programmable display 4. The screen transition object is selected, for example, by a touch on the screen transition object.

Next, the screen transition information input processing unit 51d executes a subroutine for a screen transition information input process in step S142.

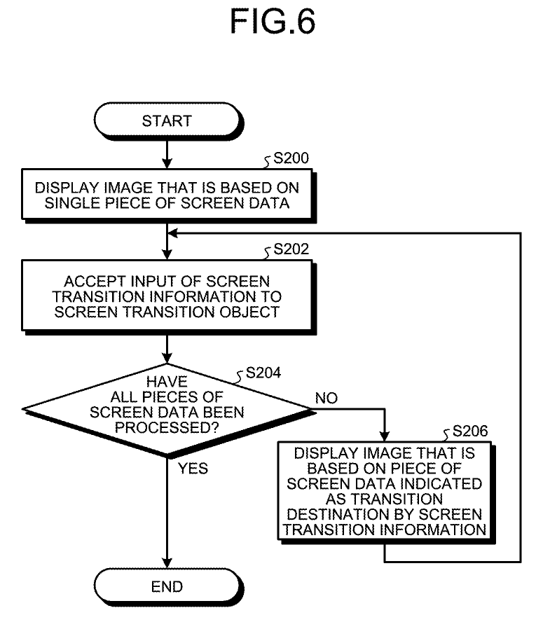

FIG. 6 is a flowchart illustrating the subroutine for the screen transition information input process according to the first embodiment.

First, in step S200, the screen transition information input processing unit 51d displays, on the display unit 56, an image that is based on one of the plurality of pieces of screen data created by the screen data creation processing unit 51c.

Next, the screen transition information input processing unit 51d displays a screen transition information input dialogue box on the display unit 56, and accepts input of screen transition information to the screen transition object in step S202. The screen transition information is information for uniquely specifying, in response to being selected by the operator, another image to which the display is changed. The screen transition information input processing unit 51d describes the input screen transition information in the screen transition object.

Next, the screen transition information input processing unit 51d determines in step S204 whether all the pieces of screen data have been processed.

When the screen transition information input processing unit 51d determines in step S204 that not all the pieces of screen data have been processed (No), the screen transition information input processing unit 51d advances the process to step S206.

In step S206, the screen transition information input processing unit 51d displays, on the display unit 56, an image that is based on a piece of screen data indicated as a transition destination by the screen transition information input in step S202, and advances the process to step S202.

Returning to step S204, when the screen transition information input processing unit 51d determines that all the pieces of screen data have been processed (Yes), the screen transition information input processing unit 51d finishes the subroutine process for the screen transition information input.

Referring again to FIG. 5, in step S144, the device name input processing unit 51e displays a device name input dialogue box on the display unit 56, and accepts input of a device name for uniquely specifying a memory area in the PLC 2 to the object arranged in the one or more pieces of created screen data. The device name input processing unit 51e then finishes the process.

Next, the image data will be described with reference to specific examples. First, a case where the number of pieces of image data is one will be described.

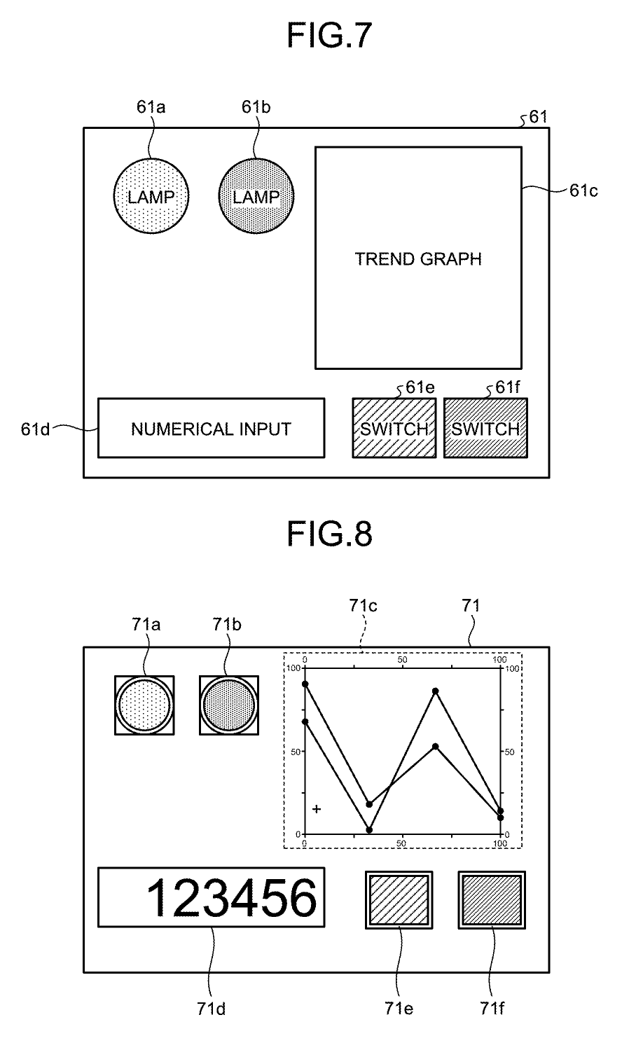

FIG. 7 is a diagram illustrating exemplary image data according to the first embodiment. In the upper part of the image data 61 illustrated in FIG. 7, a circle 61a, a circle 61b, and a quadrilateral 61c are drawn. A character string “lamp” is drawn in the circle 61a. A character string “lamp” is drawn in the circle 61b. A character string “trend graph” is drawn in the quadrilateral 61c.

In the lower part of the image data 61, a quadrilateral 61d, a quadrilateral 61e, and a quadrilateral 61f are drawn. A character string “numerical input” is drawn in the quadrilateral 61d. A character string “switch” is drawn in the quadrilateral 61e. A character string “switch” is drawn in the quadrilateral 61f.

The recognition processing unit 51b recognizes the FIG. 61b and the character string in the FIG. 61b, the FIG. 61c and the character string in the FIG. 61c, the FIG. 61d and the character string in the FIG. 61d, the FIG. 61e and the character string in the FIG. 61e, and the FIG. 61f and the character string in the FIG. 61f drawn in the image data 61.

The recognition processing unit 51b then searches the library data 54a using the FIG. 61b and the character string in the FIG. 61b, the FIG. 61c and the character string in the FIG. 61c, the FIG. 61d and the character string in the FIG. 61d, the FIG. 61e and the character string in the FIG. 61e, and the FIG. 61f and the character string in the FIG. 61f recognized, thereby acquiring a plurality of objects correlated with the FIG. 61b and the character string in the FIG. 61b, the FIG. 61c and the character string in the FIG. 61c, the FIG. 61d and the character string in the FIG. 61d, the FIG. 61e and the character string in the FIG. 61e, and the FIG. 61f and the character string in the FIG. 61f recognized.

FIG. 8 is a diagram illustrating exemplary screen data according to the first embodiment. In order to facilitate the understanding, the screen data 71 are represented by a screen that is displayed using the description language, not by the description language itself.

In the upper part of the screen data 71, an object 71a of a lamp image, an object 71b of a lamp image, and an object 71c of a trend graph image are drawn. In the lower part of the screen data 71, an object 71d of a numerical input image, an object 71e of a switch image, and an object 71f of a switch image are drawn.

The screen data creation processing unit 51c arranges the objects acquired by the recognition processing unit 51b at positions recognized by the recognition processing unit 51b, thereby creating the screen data 71.

In a case where the quadrilaterals are correlated with the plurality of objects as illustrated in the image data 61, the library data 54a need to include figure items, character string items, and object items. However, in a case where a single figure is correlated with a single object on a one-to-one basis, the library data 54a only need to include figure items and object items.

In a case where the number of pixels of the image data 61 and the number of pixels of the display unit 44 of the programmable display 4 are different from each other, the screen data creation processing unit 51c creates the screen data 71 having the same number of pixels as the display unit 44 of the programmable display 4. For example, in a case where the image data 61 have 1280 pixels×960 pixels, and the number of pixels of the display unit 44 of the programmable display 4 is 640 pixels×480 pixels, the screen data creation processing unit 51c creates the screen data 71 having 640 pixels×480 pixels in which a smaller object with a quarter the size of each figure drawn in the image data 61 is arranged.

In a case where the image data 61 have 320 pixels×240 pixels, and the number of pixels of the display unit 44 of the programmable display 4 is 640 pixels×480 pixels, the screen data creation processing unit 51c creates the screen data 71 having 640 pixels×480 pixels in which a larger object with four times the size of each figure drawn in the image data 61 is arranged.

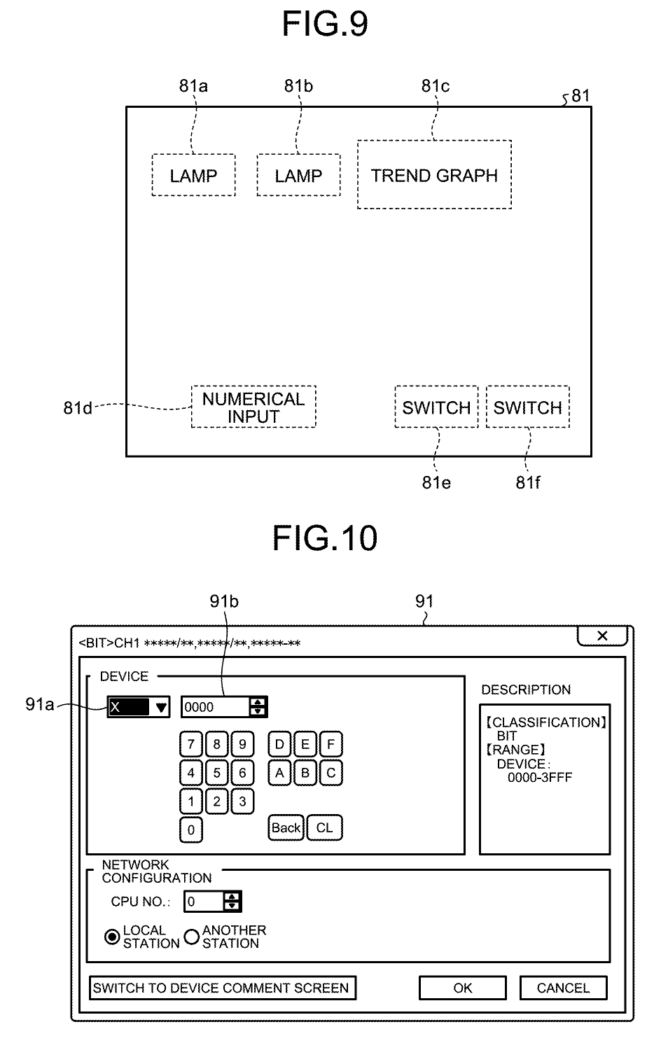

FIG. 9 is a diagram illustrating exemplary image data according to the first embodiment. In the upper part of the image data 81 illustrated in FIG. 9, a character string “lamp” 81a, a character string “lamp” 81b, and a character string “trend graph” 81c are drawn. In the lower part of the image data 81, a character string “numerical input” 81d, a character string “switch” 81e, and a character string “switch” 81f are drawn.

The recognition processing unit 51b recognizes the character strings 81a, 81b, 81c, 81d, 81e, and 81f drawn in the image data 81, and searches the library data 54a using the recognized character strings 81a, 81b, 81c, 81d, 81e, and 81f, thereby acquiring a plurality of objects correlated with the recognized character strings 81a, 81b, 81c, 81d, 81e, and 81f.

The screen data creation processing unit 51c arranges the objects acquired by the recognition processing unit 51b at positions recognized by the recognition processing unit 51b, thereby creating the screen data 71.

In a case where only the character strings are drawn as illustrated in the image data 81, the library data 54a only need to include character string items and object items.

FIG. 10 is a diagram illustrating the device name input dialogue box according to the first embodiment. The device name input processing unit 51e displays, on the display unit 56, a screen that is based on the screen data 71 created by the screen data creation processing unit 51c, and further displays the device name input dialogue box 91 on the display unit 56.

The device name is represented by a combination of an alphabetical character and a four-digit number. The operator inputs an alphabetical character in an input field 91a, and inputs a four-digit number in an input field 91b. The device name input processing unit 51e describes, in the object 71a, the device name input to the device name input dialogue box 91.

The device name input processing unit 51e then sequentially displays the device name input dialogue boxes 91 for the objects 71b, 71c, 71d, 71e, and 71f, and describes, in the object 71a, the device names input to the device name input dialogue boxes 91. The creation of the screen data 71 is thus finished. The project data 43a including the created screen data 71 are transferred to the programmable display 4 as they are or after being compiled into a binary format.

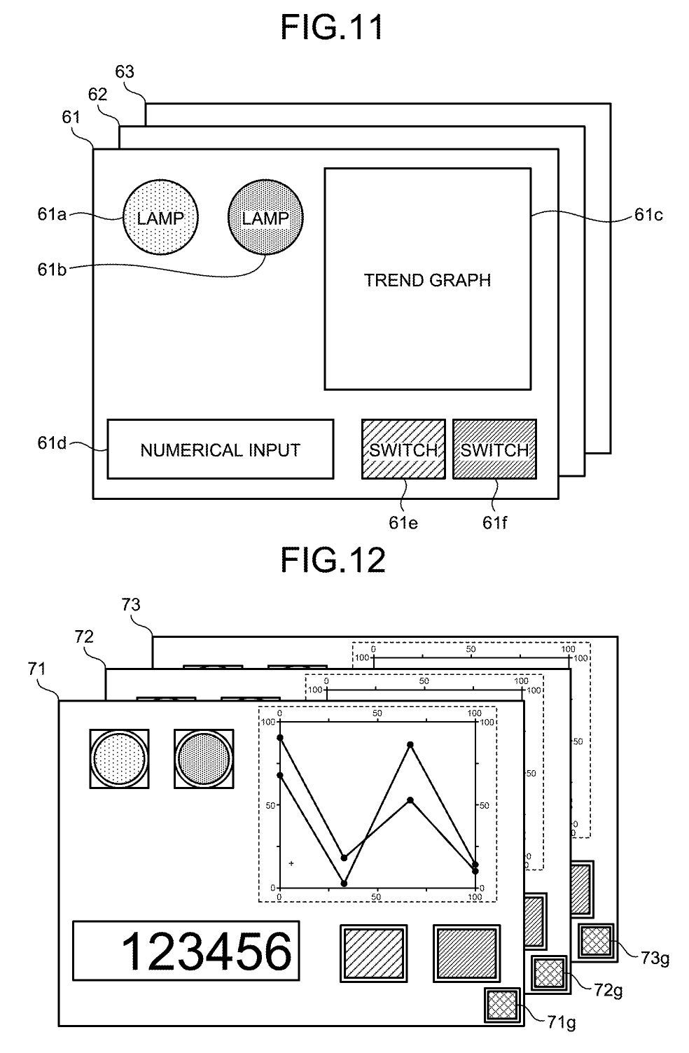

Next, a case where the number of pieces of image data is more than one will be described with reference to specific examples. FIG. 11 is a diagram illustrating a plurality of pieces of image data according to the first embodiment.

The recognition processing unit 51b recognizes the FIG. 61b and the character string in the FIG. 61b, the FIG. 61c and the character string in the FIG. 61c, the FIG. 61d and the character string in the FIG. 61d, the FIG. 61e and the character string in the FIG. 61e, and the FIG. 61f and the character string in the FIG. 61f drawn in the image data 61.

The recognition processing unit 51b then searches the library data 54a using the FIG. 61b and the character string in the FIG. 61b, the FIG. 61c and the character string in the FIG. 61c, the FIG. 61d and the character string in the FIG. 61d, the FIG. 61e and the character string in the FIG. 61e, and the FIG. 61f and the character string in the FIG. 61f recognized, thereby acquiring the plurality of objects correlated with the FIG. 61b and the character string in the FIG. 61b, the FIG. 61c and the character string in the FIG. 61c, the FIG. 61d and the character string in the FIG. 61d, the FIG. 61e and the character string in the FIG. 61e, and the FIG. 61f and the character string in the FIG. 61f recognized.

The recognition processing unit 51b then sequentially executes, for pieces of image data 62 and 63, a process similar to that for the image data 61, and sequentially acquires objects correlated with figures and character strings drawn in the pieces of image data 62 and 63.

FIG. 12 is a diagram illustrating a plurality of pieces of screen data according to the first embodiment. In order to facilitate the understanding, each of pieces of screen data 71, 72, and 73 is represented by a screen that is displayed using the description language, not by the description language itself.

The screen data creation processing unit 51c arranges the objects acquired by the recognition processing unit 51b at positions recognized by the recognition processing unit 51b, thereby creating the pieces of screen data 71, 72, and 73.

Next, the screen transition information input processing unit 51d arranges a screen transition object 71g in the screen data 71, arranges a screen transition object 72g in the screen data 72, and arranges a screen transition object 73g in the screen data 73.

Suppose the operator wants to make sure that the display screen is changed to a screen that is based on the screen data 73 when a screen that is based on the screen data 71 is displayed on the display unit 44 of the programmable display 4, and the screen transition object 71g is selected by the manipulator. In addition, suppose the operator wants to make sure that the display screen is changed to a screen that is based on the screen data 72 when the screen that is based on the screen data 73 is displayed on the display unit 44 of the programmable display 4, and the screen transition object 73g is selected by the manipulator. In addition, suppose the operator wants to make sure that the display screen is changed to the screen that is based on the screen data 71 when the screen that is based on the screen data 72 is displayed on the display unit 44 of the programmable display 4, and the screen transition object 72g is selected by the manipulator.

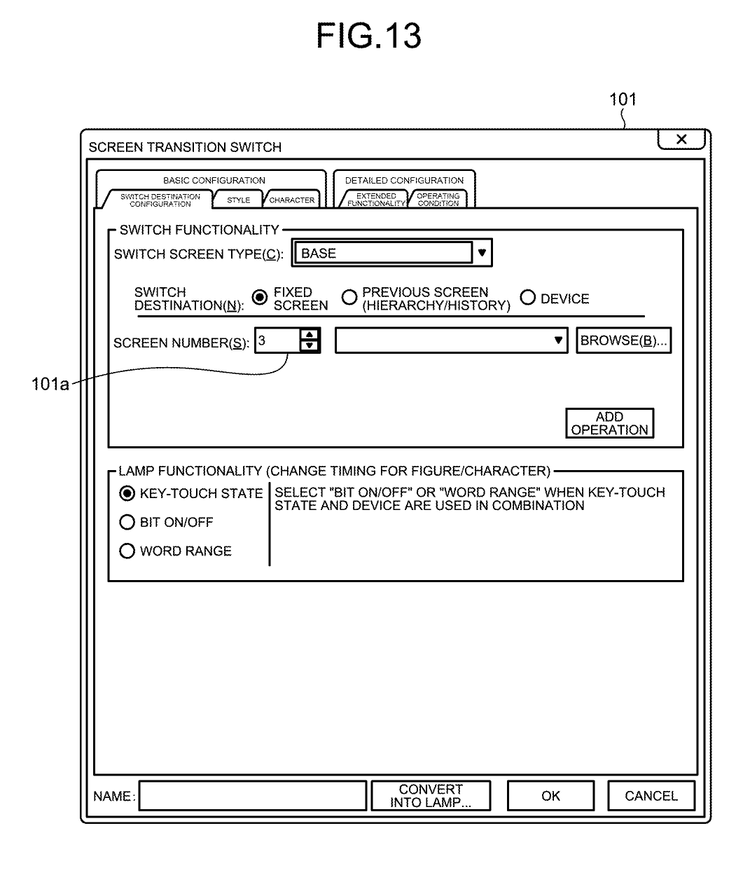

FIG. 13 is a diagram illustrating an exemplary screen transition information input dialogue box according to the first embodiment. The screen transition information input processing unit 51d displays the screen that is based on the screen data 71 on the display unit 56, and displays the screen transition information input dialogue box 101 on the display unit 56.

The operator inputs, in an input field 101a, a number “3” that is the screen transition information indicating the screen data 73 as the transition destination. The screen transition information input processing unit 51d describes, in the screen transition object 71g, the number “3” that is the screen transition information input to the input field 101a.

Next, the screen transition information input processing unit 51d displays, on the display unit 56, the screen that is based on the screen data 73 indicated by the number “3”, i.e., the screen transition information, and displays the screen transition information input dialogue box 101 on the display unit 56.

The operator inputs, in the input field 101a, a number “2” that is the screen transition information indicating the screen data 72 as the transition destination. The screen transition information input processing unit 51d describes, in the screen transition object 73g, the number “2” that is the screen transition information input to the input field 101a.

Next, the screen transition information input processing unit 51d displays, on the display unit 56, the screen that is based on the screen data 72 indicated by the number “2”, i.e., the screen transition information, and displays the screen transition information input dialogue box 101 on the display unit 56.

The operator inputs, in the input field 101a, a number “1” that is the screen transition information indicating the screen data 71 as the transition destination. The screen transition information input processing unit 51d describes, in the screen transition object 72g, the number “1” that is the screen transition information input to the input field 101a. The creation of the pieces of screen data 71, 72, and 73 is thus finished. The project data 43a including the created pieces of screen data 71, 72, and 73 are transferred to the programmable display 4 as they are or after being compiled into a binary format.

In the above example, the figures and the character strings are correlated with the objects in the library data 54a. However, the library data 54a are not limited to this example.

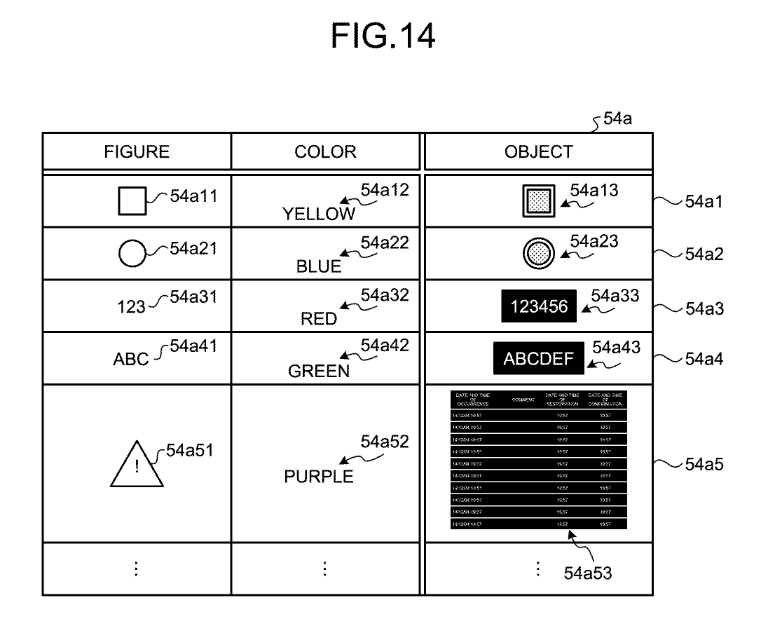

FIG. 14 is a diagram illustrating exemplary library data according to the first embodiment. In the library data 54a illustrated in FIG. 14, figures and colors are correlated with objects. In other words, the library data 54a include figure items, color items, and object items.

In the first row 54a1 of the library data 54a, the quadrilateral 54a11 and a character string “yellow” 54a12 are correlated with the object 54a13, namely, the switch image for display in a screen that is displayed on the display unit 44 of the programmable display 4.

In the second row 54a2 of the library data 54a, the circle 54a21 and a character string “blue” 54a22 are correlated with the object 54a23, namely, the lamp image for display in a screen that is displayed on the display unit 44 of the programmable display 4.

In the third row 54a3 of the library data 54a, the FIG. 54a31 of bold “123” and a character string “red” 54a32 are correlated with the object 54a33, namely, the numerical display image for display in a screen that is displayed on the display unit 44 of the programmable display 4.

In the fourth row 54a4 of the library data 54a, the FIG. 54a41 of bold “ABC” and a character string “green” 54a42 are correlated with the object 54a43, namely, the character string display image for display in a screen that is displayed on the display unit 44 of the programmable display 4.

In the fifth row 54a5 of the library data 54a, the FIG. 54a51 of the exclamation mark drawn in the triangle and a character string “purple” 54a52 are correlated with the object 54a53, namely, the alarm display image for display in a screen that is displayed on the display unit 44 of the programmable display 4.

In this case, image data do not include a character drawn in a figure, and only need to include a color applied in a figure. The recognition processing unit 51d recognizes the figure and the color applied in the figure. The screen data creation processing unit 51c searches the library data 54a using the figure and the color recognized by the recognition processing unit 51b, acquires an object correlated with the figure and the color recognized by the recognition processing unit 51b, and creates screen data.

As described above, the data creating device 5 creates the screen data 71 based on the image data 61 or 81.

Consequently, the data creating device 5 can reduce the necessity for the operator to create the screen data from the beginning while watching an image that is based on the image data. As a result, the data creating device 5 can reduce the operator's workload and suppress a human error by the operator.

The data creating device 5 also creates the pieces of screen data 71, 72, and 73 based on the pieces of image data 61, 62, and 63. The data creating device 5 then arranges the screen transition objects 71g, 72g, and 73g in the pieces of screen data 71, 72, and 73, respectively.

Consequently, the data creating device 5 can create the plurality of pieces of screen data 71, 72, and 73 including the items of screen transition information based on the plurality of pieces of image data 61, 62, and 63. As a result, the data creating device 5 can reduce the operator's workload and suppress a human error by the operator.

Furthermore, the data creating device 5 displays the image that is based on the screen data 73 when “3” indicating the transition destination screen is input to the screen transition object 71g. Subsequently, the data creating device 5 displays the image that is based on the screen data 72 when “2” indicating the transition destination screen is input.

Consequently, the data creating device 5 can display the screens on the display unit 56 in the transition order, and accept the input of the items of screen transition information in the transition order. As a result, the data creating device 5 can suppress a human error by the operator in the input of the items of screen transition information.

The configuration described in the above-mentioned embodiment indicates an example of the contents of the present invention. The configuration can be combined with another well-known technique, and a part of the configuration can be omitted or changed in a range not departing from the gist of the present invention.

### REFERENCE SIGNS LIST

1 control system, 2 PLC, 4 programmable display, 5 data creating device, 51 CPU, 51a import processing unit, 51b recognition processing unit, 51c screen data creation processing unit, 51d screen transition information input processing unit, 51e device name input processing unit, 52 RAM, 54 storage unit, 54a library data, 61, 62, 63, 81 image data, 71, 72, 73 screen data, 91 device name input dialogue box, 101 screen transition information input dialogue box.

1. A data creating device comprising:
a memory to store library data in which character strings are correlated with objects for displaying data acquired from a control device or sending data to the control device;
a recognition processor to recognize a character string drawn in one or more pieces of image data in which a figure is not drawn;
a screen data creation processor to search the library data using the character string recognized by the recognition processor to acquire an object correlated the character string recognized by the recognition processor, and create one or more pieces of screen data in which the acquired object is arranged; and
a device name input processor to accept input of a device name to the object arranged in the one or more pieces of screen data, the device name uniquely specifying a memory area in the control device.

2. (canceled)

3. The data creating device according to claim 1, further comprising:
a screen transition information processor to arrange a screen transition object in each of the pieces of screen data in response to the screen data creation processor creating the pieces of screen data, and accept input of screen transition information to the screen transition object in each of the pieces of screen data, the screen transition information indicating a piece of screen data that is reached as a transition destination when the screen transition object is selected.

4. The data creating device according to claim 3, wherein
the screen transition information input processor displays an image that is based on one of the pieces of screen data, displays, in response to the screen transition information being input to the screen transition object in the one of the pieces of screen data, an image that is based on a piece of screen data indicated as a transition destination by the input screen transition information from among the pieces of screen data, and accepts input of the screen transition information to the screen transition object in the piece of screen data that is the transition destination.

5. A data creating method comprising:
a recognition step of recognizing a character string drawn in one or more pieces of image data in which a figure is not drawn;
a screen data creation step of searching, using the character string recognized, library data in which character strings are correlated with objects for displaying data acquired from a control device or sending data to the control device, to acquire an object correlated with the character string recognized, and create one or more pieces of screen data in which the acquired object is arranged; and
a device name input step of accepting input of a device name to the object arranged in the one or more pieces of screen data, the device name uniquely specifying a memory area in the control device.

6. A data creating program to cause a computer to execute:
a recognition step of recognizing a character string drawn in one or more pieces of image data in which a figure is not drawn;
a screen data creation step of searching, using the character string recognized, library data in which character strings are correlated with objects for displaying data acquired from a control device or sending data to the control device, to acquire an object correlated with the character string recognized, and create one or more pieces of screen data in which the acquired object is arranged; and
a device name input step of accepting input of a device name to the object arranged in the one or more pieces of screen data, the device name uniquely specifying a memory area in the control device.
